(19) United States
(12) Patent Application Publication
(10) Pub. No.: US 2010/0006505 A1
(43) Pub. Date: Jan. 14, 2010

(54) FILTER WITH IODINATED RESIN AND FILTER LIFE INDICATOR

(76) Inventors: Terryll Riley Smith, Reno, NV (US); James J. Kubinec, Reno, NV (US)

Correspondence Address: K&L GATES LLP, 535 SMITHFIELD STREET, PITTSBURGH, PA, 15222, US

(21) Appl. No.: 12/500,913

(22) Filed: Jul. 10, 2009

Related U.S. Application Data
(60) Provisional application No. 61/079,595, filed on Jul. 10, 2008.

(51) Int. Cl. B01D 15/04

(52) U.S. Cl. 210/660; 210/94

(57) ABSTRACT

A filter having a flow path for a filtrate may generally comprise an iodinated resin, wherein the iodinated resin releases iodine into the filtrate, and an ion exchange column downstream from the iodinated resin, the ion exchange column comprising at least one ion exchange resin, wherein the at least one ion exchange resin progressively changes color as iodine is absorbed from the filtrate, and an indicator to indicate when the amount of iodine in the iodinated resin reaches a predetermined lower threshold. Other embodiments include methods of using embodiments of the filter described herein.

### CROSS-REFERENCE TO RELATED APPLICATIONS

This application claims the benefit under 35 U.S.C. §119(e) of U.S. Provisional Application No. 61/079,595 filed on Jul. 10, 2008.

### BACKGROUND

This application generally relates to filters and apparatuses for removing contaminants from a fluid as well as methods of making and using the same.

Filters including halogenated release systems have been successfully used as to remove contaminants from water and other fluids. The halogens are released from the halogenated release systems into the fluid passing therethrough. Filters including halogenated release systems generally remain effective as long as the halogenated release system continues to release an effective amount of halogen into the fluid. When the halogenated release system is no longer releasing an effective amount of halogen into the fluid, at least the halogenated release system should be replaced.

Filters including halogenated release systems may incorporate a means of predicting when the halogenated release systems should be replaced. For example, a filter including a halogenated release system may comprise a flow meter to measure the volume of water passing through the filter. The flow meter may indicate when a predetermined volume of water has passed through the filter. This predetermined volume of water may be pre-calculated to correlate to a minimum safe volume of water that the halogenated release system is capable of treating under the harshest predicted operating environment.

This may be problematic, however, because the predicted operating environment may be different from the actual operating environment. For example, more halogen may be released by a halogenated release system in warm operating environments than in more moderate environments. Therefore, the predetermined volume of water calculated based on a warm operating environment that is used in a more moderate environment may indicate that the halogenated release system should be replaced even though the halogenated release system may remain effective in this environment for a greater volume of water.

Therefore, a filter including a halogenated release system and a means for determining when a predetermined lower threshold amount of halogen remains in the halogenated release system under any operating condition is desirable.

### SUMMARY

In certain embodiments, a filter having a flow path for a filtrate may generally comprise an iodinated resin, wherein the iodinated resin releases iodine into the filtrate, and an ion exchange column downstream from the iodinated resin, the ion exchange column comprising at least one ion exchange resin, wherein the at least one ion exchange resin progressively changes color as iodine is absorbed from the filtrate, and an indicator to indicate when the amount of iodine in the iodinated resin reaches a predetermined lower threshold.

In certain embodiments, a method for determining when a filter is no longer intended for use may generally comprise providing a filter having a flow path for a filtrate comprising an iodinated resin, wherein the iodinated resin releases iodine into the filtrate, and an ion exchange column downstream from the iodinated resin, the ion exchange column comprising at least one ion exchange resin, wherein the at least one ion exchange resin progressively changes color as iodine is absorbed from the filtrate, and an indicator to indicate when the amount of iodine in the iodinated resin reaches a predetermined lower threshold, calibrating the ion exchange column to the predetermined lower threshold, and monitoring the indicator.

### DESCRIPTION OF THE DRAWINGS

The various embodiments described herein may be better understood by considering the following description in conjunction with one or more of the accompanying drawings. The sizes, shapes, and relative positions of elements in the drawings may not be drawn to scale and some of these elements may be arbitrarily enlarged and/or positioned to solely improve legibility.

FIG. 1 is a diagram illustrating an embodiment of a filter including an iodinated resin, an ion exchange column, and an indicator.

FIG. 2 is a diagram illustrating an embodiment of a filter including an indicator positioned intermediate the ends of the ion exchange column.

FIG. 3 is a diagram illustrating an embodiment of a filter including an iodinated resin, an ion exchange column, and an indicator.

### DETAILED DESCRIPTION

### A. Definitions

As generally used herein, the term “comprising” refers to various components conjointly employed in the manufacture and/or use of the filters and apparatuses described herein. Accordingly, the terms “consisting essentially of” and “consisting of” are embodied in the term “comprising”.

As generally used herein, the articles including “the”, “a” and “an” refer to one or more of what is claimed or described.

As generally used herein, the terms “include”, “includes” and “including” are meant to be non-limiting.

As generally used herein, the terms “have”, “has” and “having” are meant to be non-limiting.

As generally used herein, the terms “about” and “approximately,” refer to an acceptable degree of error for the quantity measured, given the nature or precision of the measurements. Typical exemplary degrees of error may be within 20%, 10%, or 5% of a given value or range of values. Alternatively, and particularly in biological systems, the terms “about” and “approximately” may mean values that are within an order of magnitude, potentially within 5-fold or 2-fold of a given value.

All numerical quantities stated herein are approximate unless stated otherwise, meaning that the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

As generally used herein, “contaminant” may refer to any undesirable agent in a gas, vapor, or liquid fluid or solution. “Contaminant” may include, for example, but not limited to, heavy metals, such as lead, nickel, mercury, copper, etc.; polyaromatics; halogenated polyaromatics; minerals; vitamins; microorganisms or microbes (as well as reproductive forms of microorganisms, including cysts and spores) including viruses, such as enteroviruses (polio, Coxsackie, echovirus, hepatitis, calcivirus, astrovirus), rotaviruses and other reoviruses, adenoviruses Norwalk-type agents, Snow Mountain agent, fungi (for example, molds and yeasts); helminthes; bacteria (including salmonella, shigella, yersinia, fecal coliforms, mycobacteria, enterocolitica, E. coli, Campylobacter, Serratia, Streptococcus, Legionella, Cholera); flagellates; amoebae; Cryptosporidium, Giardia, other protozoa; prions; proteins and nucleic acids; pesticides and other agrochemicals including organic chemicals (such as acrylamide, alachlor, atrazine, benzene, benzopyrene, carbfuran, carbon tetrachloride, chlordane, chlorobenzene, 2,4-D, dalapon, diquat, o-dichlorobenzene, p-dichlorobenzene, 1,2-dichloroethane, 1,1-dichloroethylene, cis-1,2-dichloroethylene), dichloropropane, 1,2-dichloropropane, di(2-ethylhexyl)adipate, di(2-ethylhexyl)phthalate, dinoseb, dioxin, 1,2-diobromo-3-chloropropane, endothall, endrin, epichlorohydrin, ethylbenzene, ethylene dibromide, heptachlor, heptachlor epoxide, hexachlorobenzene, hexachlorocyclopentadiene, lindane, methoxychlor, oxamyl, polychlorinated biphenyls, pentachlorophenol, picloram, simazine, tetrachloroethylene, toluene, toxaphene, 2,4,5-TP, 1,2,4-trichlorobenzene, 1,1,1-trichloroethane, 1,1,2-trichloroethane, trichloroethylene, vinyl chloride, xylenes); halogenated organic chemicals; inorganic chemicals (such as antimony, arsenic, asbestos, barium, beryllium, cadmium, chromium, copper, cyanide, fluoride, lead, mercury, nitrate, selenium, and thalium); radioactive isotopes; and certain polyvalent dissolved salts; as well as other debris.

As generally used herein, the phrase “log reduction value” refers to the Log₁₀ of the level of contaminants (typically the number of microorganisms) in the influent fluid divided by the level of contaminants (typically the number of microorganisms) in the effluent fluid of the filter media encompassed by the present invention. For example, a log 4 reduction in contaminants is >99.99% reduction in contaminants, whereas a log 5 reduction in contaminants is >99.999% reduction in contaminants. In at least one embodiment, the present invention includes methods and apparatuses or systems that may indicate at least a log 4 to log 5, log 5 to log 6, or log 6 to log 7 kill or removal of most microorganisms, potentially including viruses. In at least one embodiment, the present invention may indicate at least a log 7 to log 8 kill or removal of most microorganisms, potentially including viruses. In at least one embodiment, the present invention may indicate at least a log 8 to log 9 kill or removal of most microorganisms, potentially including viruses.

As generally used herein, “removing contaminants” refers to disarming one or more contaminants in the fluid, whether by physically or chemically removing, reducing, inactivating the contaminants or otherwise rendering the one or more contaminants harmless. Certain aspects may include removing one or more contaminants but specifically excludes one or more types, groups, categories or specifically identified contaminants as well. For example, in certain aspects, “removing contaminants” may include one or more contaminants, or may include only one particular contaminant, or may specifically exclude one or more contaminants.

As generally used herein, “sorbent media” and “sorbent medium” refer to any material that may absorb or adsorb at least one contaminant. In general, “absorbent” materials may include materials capable of drawing substances, including contaminants, into their surfaces or structures, and “adsorbent” materials may include materials that are capable of physically holding substances, including contaminants, on their outer surfaces.

In certain aspects, one or more of the filter media components may be immobilized utilizing binders, matrices or other materials that hold the media components together. Some examples of binders and/or matrices include but are not limited to powdered polyethylene, end-capped polyacetals, acrylic polymers, fluorocarbon polymers, perfluorinated ethylene-propylene copolymers, ethylene-tetrafluoroethylene copolymers, polyamides, polyvinyl fluoride, polyaramides, polyaryl sulfones, polycarbonates, polyesters, polyaryl sulfides, polyolefins, polystyrenes, polymeric microfibers of polypropylene, cellulose, nylon, or any combination thereof. Some of these examples may be found in U.S. Pat. Nos. 4,828,698 and 6,959,820.

The headings provided herein are for convenience only and do not interpret or limit the scope or meaning of the claims in any manner.

In the following description, certain details are set forth in order to provide a thorough understanding of various embodiments of the present disclosure. However, one skilled in the art will understand that the embodiments of the present disclosure may be practiced without these details. In other instances, well-known structures and methods associated with aqueous filtration or purification devices and/or systems and methods of using and making the same may not be shown or described in detail to avoid unnecessarily obscuring descriptions of the embodiments of the disclosure.

This disclosure describes various features, aspects, and advantages of various embodiments of apparatuses and methods for removing contaminants from a fluid. It is understood, however, that this disclosure embraces numerous alternative embodiments that may be accomplished by combining any of the various features, aspects, and advantages of the various embodiments described herein in any combination or sub-combination that one of ordinary skill in the art may find useful.

### B. Overview

In certain embodiments, a water treatment system may generally comprise a multi-barrier filter comprising at least one halogenated release system and at least one contaminant sorbent medium downstream of the halogenated release system capable of adsorbing or absorbing contaminants. In conventional filters, it may not be ascertained how much halogen remains in the halogenated release system merely by viewing the halogenated release system. In certain embodiments, an apparatus is described wherein it can be ascertained when the amount of halogen in a halogenated release system has reached a predetermined lower threshold by monitoring another component of the filter. In at least one embodiment, the predetermined lower threshold may correlate to the end of the iodinated resin's useful life. In at least one embodiment, the predetermined lower threshold may correlate to an effective amount of iodine remaining in the iodinated resin to ensure an adequate removal of contaminants and/or log kill of contaminants.

The present invention generally relates to removing contaminants from a fluid. One of skill in the art would readily recognize that a fluid may comprise a liquid (such as water) and other fluids. For example, the fluid to be purified may be a bodily fluid (such as blood, lymph, urine, etc.), water in rivers, lakes, streams or the like, standing water or runoff, seawater, water for swimming pools or hot tubs, water or air for consumption in public locations (such as hotels, restaurants, aircraft or spacecraft, ships, trains, schools, hospitals, etc.), water for consumption in private locations (such as homes, apartment complexes, etc.), water for use in manufacturing computer or other sensitive components (such as silicon wafers), water for use in biological labs or fermentation labs, water or air for use in plant-growing operations (such as hydroponic or other greenhouses), wastewater treatment facilities (such as from mining, smelting, chemical manufacturing, dry cleaning or other industrial waste), or any other fluid that is desired to be purified.

### C. Halogenated Release Systems

In certain embodiments, a filter may include a halogenated release system generally comprising at least one halogenated resin. In at least one embodiment, the halogenated release system may comprise two halogenated resins. In at least one embodiment, the halogenated resin may comprise halogens selected from the group consisting of chlorine, bromine, iodine and any combination thereof. In at least one embodiment, the halogenated resin may be selected from the group consisting of chlorinated resins, brominated resins, iodinated resins, low-residual halogenated resins, and any combination thereof. In at least one embodiment, the halogenated resin may comprise an iodinated resin. In at least one embodiment, the low-residual halogenated resin may comprise a low-residual iodinated resin. Halogenated resins are described in U.S. patent application Ser. No. 11/823,804, filed on Jun. 28, 2007. In at least one embodiment, a multi-barrier filter may comprise at least one halogenated release system selected from the group consisting of iodinated release systems, chlorinated release systems, brominated release systems, and any combination thereof.

In certain embodiments, the halogenated resin may comprise an iodinated resin comprising an iodinated base ion exchange resin of polyiodide anions bound to the quaternary amine fixed charges of a polymer. In at least one embodiment, the iodinated resin may comprise a Microbial Check Valve or MCV® Resin. The MCV® Resin contains an iodinated strong base ion exchange resin of polyiodide anions bound to the quaternary amine fixed positive charges of a polystyrene-divinylbenzene copolymer. Polyiodide anions are formed in the presence of excess iodine in an aqueous solution, and accordingly, bound polyiodide anions release iodine into the water. Water flowing through the MCV® Resin achieves a microbial kill as well as residual iodine ranging between about 0.5-4.0 mg/L, which decreases the buildup of biofilm in storage and/or dispensing units.

MCV® Resin consistently kills over 99.9999% of bacteria (log 6 kill) and 99.99% of viruses (log 4 kill) found in contaminated water. In addition, a replacement cartridge, called regenerative MCV (RMCV) has been developed. The RMCV utilizes a packed bed of crystalline elemental iodine to produce a saturated aqueous solution that is used to replenish depleted MCV® Resin. Tests have shown the RMCV can be regenerated more than 100 times. The use of a regenerative system reduces the overall cost of operating an iodine delivery system and eliminates the hazards associated with chlorine.

There are many known methods for making halogenated release systems, including iodinated resins. For example, U.S. Pat. Nos. 5,980,827; 6,899,868 and 6,696,055 describe methods of making halogenated or strong base anion exchange resins for purification of fluids such as air and water. Briefly, examples of making iodinated resins include reacting a porous strong base anion exchange resin in a salt form with a sufficient amount of an iodine substance absorbable by the anion exchange resin such that the anion exchange resin absorbs the iodine substance and converts the anion exchange resin to an iodinated resin. If necessary, the iodinated resin reaction may be conducted in an elevated temperature and/or elevated pressure environment.

As generally used herein, a “low residual” halogenated resin may have a significantly lower level of halogen release than a “classic” halogenated resin. In one example, with deionized water, iodine release from a “classic” resin is approximately 4 ppm. According to certain embodiments, the iodine released from a low residual iodinated resin may be less than 4 ppm. In other embodiments, the iodine released from a low residual iodinated resin may be between 0.1 and 2 ppm. In still other embodiments, the iodine released from a low residual iodinated resin may be between 0.2 and 1 ppm. In certain other embodiments, the iodine released from a low residual iodinated resin may be between 1 ppm and 0.5 ppm. In further embodiments, the iodine released from a low residual iodinated resin may be between 0.5 ppm and 0.2 ppm or less. In still further embodiments, the iodine released from a low residual iodinated resin may be 0.2 ppm or less. As one of skill in the art will recognize, the halogen release from the release system may be dependent on various factors, including but not limited to, eluent pH, temperature and flow rate, as well as the characteristics of the fluid (such as the level of contamination, including the amount of total dissolved solids or sediment, etc.).

### D. Contaminant Sorbent Media

In certain embodiments, the filter may generally comprise one or more contaminant sorbent media and one or more halogenated release systems. In certain aspects, if more than one contaminant sorbent media is included, the same or multiple different contaminant sorbent media are considered for each one. In certain aspects, if more than one contaminant sorbent media is included, some media may be the same and others may be different. Multiple contaminant sorbent media may be physically or chemically separated from each other, or they may be physically or chemically joined with each other. Accordingly, the filter media may have multiple layers, some with the same media and others with different media utilized. In at least one embodiment, the one or more contaminant sorbent media may be any appropriate material that absorbs or adsorbs any contaminant from the selected fluid. In at least one embodiment, the one or more contaminant sorbent media may be any appropriate material that absorbs or adsorbs halogens from the selected fluid, for example iodine.

In certain embodiments, the filter may comprise barriers which do not adsorb or absorb halogens, or react with or provide catalytic reaction sites for the conversion of halogens to an ionic form. In some embodiments, barriers may adsorb fewer, absorb fewer, or convert fewer halogens to ionic form relative to another material or standard. One such standard is an “iodine number.” As generally used herein, the iodine number refers to the amount (in milligrams) of iodine adsorbed by one gram of a sorbent material. Materials that exhibit minimal or reduced adsorption, absorption, and ionic conversion of halogens are hereinafter collectively referred to as “halogen-neutral barriers.”

Halogens that become adsorbed or absorbed or are converted to an ionic form may have reduced antimicrobial action or may become ineffective altogether. By allowing more halogens to remain in the fluid through the halogen-neutral barriers, the halogens may act more effectively as antimicrobial agents in the multi-barrier filter. The characteristics of the “multi-barrier” filter media allow for prolonged contact of the halogens with the fluid to be purified, thus potentially increasing the efficiency of microbial kill and disarmament. This may lead to increased flow rates and a broader range of filtration conditions, such as, for example, pH. In addition, the surprising synergy of the combination of one or more contaminant sorbent media with one or more halogenated release systems allows for the use of smaller amounts of both components, especially in portable systems, and may reduce the overall cost. Also, due to the increased efficiency of multi-barrier fluid purification systems set forth herein, the amount of halogens required in the fluid may be reduced, which, in turn, may allow for the use of low residual halogenated release systems.

In certain embodiments, halogen-neutral contaminant sorbent media, which may be at least partially defined by iodine number, may be provided. In one embodiment, a halogen-neutral barrier of the present disclosure may comprise a contaminant sorbent medium with an iodine number less than 600 mg/g. In another embodiment, a halogen-neutral barrier may comprise a contaminant sorbent medium with an iodine number less than 300 mg/g. In yet another embodiment, a halogen-neutral barrier may comprise a contaminant sorbent medium with an iodine number less than 200 mg/g. In still another embodiment, a halogen-neutral barrier may comprise a contaminant sorbent medium with an iodine number from 100 to 200 mg/g. In another embodiment, a halogen-neutral barrier may comprise a contaminant sorbent medium with an iodine number from 0 to 100 mg/g. In still another embodiment, a halogen-neutral barrier may comprise a contaminant sorbent medium with an iodine number from 0 to 50 mg/g. In another embodiment, a halogen-neutral barrier may comprise a contaminant sorbent medium with an iodine number from 0 to 10 mg/g. In still another embodiment, a halogen-neutral barrier may comprise a contaminant sorbent medium with an iodine number of about 0 mg/g.

Since halogens, and particularly chlorine and iodine, function efficiently as antimicrobial agents, it may be desirable to include one or more halogenated release systems in fluid purification media. However, most halogens impart an unsavory flavor to the fluid, and it may be desirable to remove substantially all of the halogen once the microbes have been eliminated. In some instances, it may be desirable to retain a small amount of one or more halogens in the fluid in order to retard or inhibit microbial growth during storage, transport and/or dispensing of the fluid.

In certain other embodiments, it may be necessary to use barriers that absorb or adsorb halogens or react with or provide catalytic reaction sites for the conversion of halogens to an ionic form in order to improve smell, taste, or make the fluid suitable for drinking. In certain other embodiments, it may be necessary to use barriers that absorb or adsorb halogens or react with or provide catalytic reaction sites for the conversion of halogens to an ionic form for other reasons, for example, the removal of contaminants. These materials that may be placed in the filter for the purpose of adsorbing, absorbing, or converting halogens to ionic form, or, materials that are placed in the filter for another purpose but to adsorb, absorb, or convert halogens to ionic form, are hereinafter collectively referred to as “halogen-scavenger barriers.”

In certain embodiments, halogen-scavenger barriers may be placed downstream of halogen-neutral barriers. In this manner, halogens remain in the fluid for an effective amount of time in order to maximize their antimicrobial effect before they are removed by halogen-scavenger barriers or before being dispensed from the filter or apparatus. The use of low residual halogenated release systems may necessitate less free halogenated species being removed before dispensing the purified fluid. Indeed, it may be possible to allow the halogens to remain in the fluid if the levels are high enough for adequate microbial kill but low enough to result in safe levels of halogens in the fluid and an aesthetically pleasing taste and/or scent of the purified fluid. Therefore, in certain embodiments, a filter or apparatus may require fewer or less effective halogen-scavenger barriers, or none at all.

The contaminant sorbent media comprising halogen-neutral media may include any material(s) known or unknown in the art that may be used to absorb or adsorb at least one contaminant and/or at least one halogen. Generally, but not always, absorption occurs through micropore size filtration, while adsorption occurs through electrochemical charge filtration. Such materials may include, but not limited to, organic or inorganic microfibers or microparticulates (such as glass, ceramic, wood, synthetic cloth fibers, metal fibers, polymeric fibers, nylon fibers, lyocell fibers, etc.); polymers; polymeric adsorbents; ionic or nonionic materials; ceramics; glass; cellulose; cellulose derivatives (such as cellulose phosphate or diethyl aminoethyl (DEAE) cellulose); fabrics such as rayon, nylon, cotton, wool or silk; metal; activated alumina; silica; zeolites; diatomaceous earth; clays; sediments; kaolin; sand; loam; activated bauxite, calcium hydroxyappatite; artificial or natural membranes; nano-ceramic based materials; nano-alumina fibers (such as NanoCeram® by Argonide—see, for example, U.S. Pat. No. 6,838,005, or Structured Matrix™ by General Ecology—see, for example, Gerba and Naranjo, Wilderness Env. Med., 11, 12-16 (2000); positively charged, titanium-based adsorbents for arsenic with nanocrystalline structures (titanium oxide nano-particles), such as Adsorbsia® by the Dow Chemical Corporation, as described in U.S. Pat. No. 6,919,029; lanthanum oxide media comprising a more positive charge than activated alumina over a wide pH range, as described in, for example, U.S. Pat. No. 5,603,838; highly reactive iron, including nanoiron media, as described in, for example, U.S. Patent Application No. 20060249465 filed on Mar. 15, 2006; coated diatomaceous earth, including materials containing hydronium ions, as described in Canadian Patent No. 2,504,703. Any of the examples of adsorbent and/or absorbent materials disclosed may be bound or enmeshed in a matrix of another material, thereby forming a combination material or membrane.

The contaminant sorbent media comprising halogen-scavenger barriers may include any material(s) known or unknown in the art that may be used to absorb or adsorb at least one contaminant and/or at least one halogen. Generally, but not always, absorption occurs through micropore size filtration, while adsorption occurs through electrochemical charge filtration. Such materials may include, for example, but are not limited to, carbon or activated carbon; ion exchange resins; including anion exchange resins and more particularly strong-base anion exchange resins such as Iodosorb®, a registered trademark of Water Security Corporation, Sparks, Nev., as described in U.S. Pat. No. 5,624,567. Briefly, Iodosorb®, sometimes referred to as an iodine scrubber, comprises trialkyl amine groups each comprising from alkyl groups containing 3 to 8 carbon atoms which is capable of removing halogens, including iodine or iodide, from aqueous solutions.

In other embodiments, the contaminant sorbent media comprises at least one sorbent medium selected from the group consisting of nano-alumina fibers and ceramic material. In still other embodiments, the contaminant sorbent medium comprises nano-alumina fibers having a diameter of approximately 2 nanometers and a surface area in the range of 200 m²/gram to 650 m²/gram.

According to further embodiments, the contaminant sorbent media comprises at least one sorbent medium selected from the group consisting of organic or inorganic microfibers or microparticles, organic or inorganic nanofibers or nanoparticles, polymers, polymeric adsorbants, ionic and nonionic materials, fabrics, rayon, nylon, cotton, wool, silk, metal, activated alumina, silica, zeolites, diatomaceous earth, clays sediments, kaolin, sand, loam, activated bauxite, calcium hydroxyappatite, artificial or natural membranes, nano-alumina fibers, titanium oxide nano-particles, lanthanum oxide media, highly reactive iron/nano-iron media, and coated diatomaceous earth. Further embodiments comprise a contaminant sorbent medium comprising nano-alumina fibers selected from the group consisting of electropositive nano-alumina fibers and impregnated alumina.

In one example, nanosize electropositive fibers, such as NanoCeram®, described in U.S. Pat. No. 6,838,005, may be used as an adsorbent material, which utilizes electrokinetic forces to assist in trapping contaminants from the fluid. For example, if the electrostatic charges of the filter media and particulates or contaminants are opposite, the electrostatic attraction will facilitate the deposition and retention of the contaminants on the surface of the media. However, if the charges are similar, repulsion will occur. The surface charge of the filter is altered by changes in pH and the electrolyte concentration of the fluid being filtered. For example, lowering pH or adding cationic salts may reduce the electronegativity and allow for some adsorption to occur. Since most tap water has a pH range of between 5-9, the addition of acids and/or salts is often needed to remove viruses by electronegative filters.

Briefly, NanoCeram® fibers comprise highly electropositive aluminum hydroxide or alumina fibers approximately 2 nanometers in diameter and with surface areas ranging from 200 to 650 m²/g. When the NanoCeram® nanofibers are dispersed in water, they are able to attach to and retain electronegative particles and contaminants, including silica, organic matter, metals, DNA, bacteria, colloidal particles, viruses, and other debris. In addition to the fibers themselves, the fibers may be made into a secondary sorbent media by dispersing the fibers and/or adhering them to glass fibers and/or other fibers. The mixture may be processed to produce a nonwoven filter. Some of the characteristics of NanoCeram® include flow rates from ten to one hundred times greater than ultraporous membranes, with higher retention due to trapping by charge rather than size, endotoxin removal upwards of >99.96%, DNA removal upwards of >99.5% and filtration efficiency for micrometer-size particles upwards of >99.995%. NanoCeram® nanofibers by themselves may have a low iodine number, thought to be less than about 10 mg/g.

In addition, high surface area materials formed into fine microporous and nanoporous structures may be treated with a water-soluble high molecular weight cationic polymer and silver halide complex to obtain enhanced contaminant trapping. (See, for example, Koslow, Water Cond. & Purif., 2004.) Such materials may be more resistant to changes in variable ionic strength (mono-, di- and trivalent ions), water temperature and pH. However, performance of this type of fibers may depend on the flow velocity of the filter or apparatus, the contact time of the fluid with the fibers, the size of the pores of the filter media and the presence of a positive zeta potential (also called the electrokinetic potential).

Any of the examples of adsorbent and/or absorbent materials disclosed may be bound or enmeshed in a matrix of another material, thereby forming a combination material or membrane.

In at least one embodiment, the contaminant sorbent media comprises carbon and/or activated carbon. Activated carbon may comprise any shape or form (for example, it may be in pellets, granular, or powder form) and may be based on any acceptable origin, such as coal (especially lignite or bituminous), wood, sawdust, or coconut shells. Activated carbon may be certified for ANSI/NSF Standard 61 and ISO 9002 and/or satisfy the requirements of the U.S. Food Chemical Codex.

Activated carbon is an example of a halogen-scavenger barrier. Without being limited to any particular mechanism, activated carbon is believed to interact differently with chlorine, iodine, and bromine. Chlorine can react on the surface of activated carbon to form chloride ions. This mechanism is the basis for the removal of some common objectionable tastes and odors from drinking water due to chlorine. Through a different process it is well known that iodine is adsorbed onto the surface of activated carbon. Iodine is the most common standard adsorbate and is often used as a general measurement of carbon capacity. Because of its small molecular size, iodine more accurately defines the small pore or micropore volume of a carbon and thus reflects its ability to adsorb low molecular weight, small substances. The “iodine number” is defined as the milligrams of iodine adsorbed by one gram of carbon, and it approximates the internal surface area (square meters per gram). The iodine number of any particular activated carbon depends on many factors, but commonly ranges from 600 to 1300 mg/g.

Activated carbon may have absorptive and/or adsorptive properties, which may vary according to the carbon source. In general, the activated carbon surface is nonpolar which results in an affinity for nonpolar adsorbates, such as organic chemicals. Most adsorptive properties rely on physical forces (such as Van der Waal's forces), with saturation represented by an equilibrium point. Due to the physical nature of the adsorptive properties, the process of adsorption may be reversible (using heat, pressure, change in pH, etc.). Activated carbon is also capable of chemisorption, whereby a chemical reaction occurs at the carbon interface, changing the state of the adsorbate (for example, by dechlorination of water). In general, the adsorption capacity is proportional to the surface area (which is determined by the degree of activation) and lower temperatures generally increase the adsorption capacity (except in the case of viscous liquids). Likewise, adsorption capacity increases under pH conditions, which decrease the solubility of the adsorbate (normally lower pH). As with all adsorptive properties, sufficient contact time with the activated carbon is required to reach adsorption equilibrium and to maximize adsorption efficiency.

In at least one embodiment, one or more contaminant sorbent media comprises Universal Respirator Carbon (URC®), which is an impregnated granular activated carbon for multipurpose use in respirators or other fluid purification devices as described in U.S. Pat. No. 5,492,882. URC is composed of bituminous coal combined with suitable binders and produced under stringent conditions by high-temperature steam activation and impregnated with controlled compositions of copper, zinc, ammonium sulfate and ammonium dimolybdate (no chromium is used so disposal is simple).

In one embodiment, KX carbon may be used as one or more types of contaminant sorbent media. KX carbon is a mixture of carbon and Kevlar® that is moldable and able to trap or retain contaminants from fluids as the fluid passes over its surface. Another contaminant sorbent media that may be used with devices or apparatuses disclosed herein includes General Ecology® carbon, which includes a proprietary “structured matrix.”

In at least one aspect, the activated carbon or activated alumina is impregnated with another agent. In at least one aspect, the activated carbon is not impregnated with any other agent. Some suitable agents include sulfuric acid, molybdenum, triethylenediamine, copper, zinc, ammonium sulfate, cobalt, chromium, silver, vanadium, ammonium dimolybdate, Kevlar®, or others, or any combination thereof. These examples of activated carbon used in filtration systems are described in U.S. Pat. Nos. 3,355,317; 2,920,050; 5,714,126; 5,063,196 and 5,492,882.

### E. Filters

In certain embodiments, the filter may generally comprise one or more halogenated release systems, including any of the halogenated release systems described herein, and one or more contaminant sorbent media, including any of the contaminant sorbent media described herein. In at least one embodiment, the one or more contaminant sorbent media may have an iodine number less than 300 mg/g. In at least one embodiment, the filter comprises an iodinated resin, including any of the iodinated resins described herein, and at least one ion exchange resin, including any of the ion exchange resins described herein. In at least one embodiment, the ion exchange resin comprises an anion exchange resin. In at least one embodiment, the anion exchange resin comprises trialkyl amine groups each including alkyl groups containing from 3 to 8 carbon atoms. In at least one embodiment, the iodinated resin comprises an iodinated base ion exchange resin of polyiodide anions bound to the quaternary amine fixed charges of a polymer.

In certain embodiments, a multi-barrier filter may generally comprise a halogenated release system capable of removing contaminants from a fluid, and at least one contaminant sorbent medium downstream of the halogenated release system capable of adsorbing or absorbing contaminants. In at least one embodiment, the filter comprises one or more halogenated release systems and one or more contaminant sorbent media, wherein at least one of the contaminant sorbent media comprises carbon, and at least one of the halogenated release systems comprises an iodinated resin (such as MCV®). In at least one embodiment, the filter comprises an anion exchange base resin (such as Iodosorb®). In at least one embodiment, the filter comprises nano-alumina fibers (such as NanoCeram®). In at least one embodiment, the filter comprises a contaminant sorbent medium comprising nano-alumina fibers, and the halogenated release system comprises an iodinated resin.

In certain embodiments, the multi-barrier filter may comprise a halogenated release system capable of removing contaminants from a fluid and at least one halogen-neutral contaminant sorbent medium downstream of the halogenated release system capable of adsorbing or absorbing contaminants. In at least one embodiment, the at least one contaminant sorbent medium may have an iodine number less than 300 mg/g. The filter may comprise at least one halogen-scavenger contaminant sorbent medium downstream of the halogen-neutral media. In at least one embodiment, the halogenated release system comprises an iodinated resin, the at least one halogen-neutral contaminant sorbent media comprises nano-alumina fibers, and the at least one halogen-scavenger media comprises activated carbon. In further embodiments, the at least one halogen-scavenger media comprises activated carbon and an anion exchange base resin (such as Iodosorb®).

In certain embodiments, the filter may be configured to receive a fluid such that the fluid contacts the halogenated release system prior to contacting the contaminant sorbent medium. According to other embodiments, the fluid may comprise a gas, a vapor, or a liquid. In still other embodiments, the fluid is selected from the group consisting of a bodily fluid, urine, and water. In other embodiments, contaminants may comprise microorganisms and microbes.

In certain embodiments, the filter may comprise an ion exchange column comprising an ion exchange resin downstream from the iodinated resin. The iodinated resin may have a dark red to black color. In at least one embodiment, the iodinated resin may not change color appreciably as the iodine is depleted from the iodinated resin, even after the iodinated resin is no longer releasing an effective amount of iodine.

The ion exchange resin, before absorbing any iodine, may be a neutral color, which may be described as a clear gel color, white, yellow, or light orange. This is referred to as “pristine” ion exchange resin. As the pristine ion exchange resin begins to absorb iodine, however, it may begin to change color. The inlet end, where the filtrate enters the column, begins to change color, progressively becoming redder to black, until a dark red to black band forms at the inlet end of the ion exchange resin. The dark red to black band is referred to as a “dead zone.” Without wishing to be limited to any particular theory, it is believed that in the dead zone, the ion exchange resin has absorbed substantially the maximum amount of iodine, and can effectively absorb no more. Filtrate continues to pass through the dead zone, however, to other downstream portions of the ion exchange resin.

Just downstream from the dead zone is a “reaction zone.” The reaction zone may be a darker color than pristine ion exchange resin, but a lighter color than the dead zone. Without intending to be limited to any particular theory, it is believed that in an ion exchange resin, substantially all of the iodine being absorbed is being absorbed in the reaction zone. As the column continues to operate, the dead zone grows progressively larger, and the reaction zone moves progressively along the length of the column into the remaining pristine ion exchange resin.

The color change of an ion exchange resin or a color indicator may correlate directly to the amount of iodine released by the iodinated resin. For example, under harsh conditions, where the iodinated resin is releasing a relatively larger amount of iodine, the ion exchange column may change colors faster as the dead zone propagates along the ion exchange column at a relatively increased rate. Under more moderate conditions, where the iodinated resin is releasing a relatively smaller amount of iodine, the ion exchange column may change colors more slowly as the dead zone propagates along the ion exchange column at a relatively reduced rate. Thus, the color change may be tied directly to the amount of iodine released from the iodinated resin, regardless of conditions. In at least one embodiment, the color change may correlate to the pending exhaustion of iodine from the iodinated resin. Compared to conventional filters that use predictive mechanical or other predictive means, the color change may be a more accurate indicator of filter life.

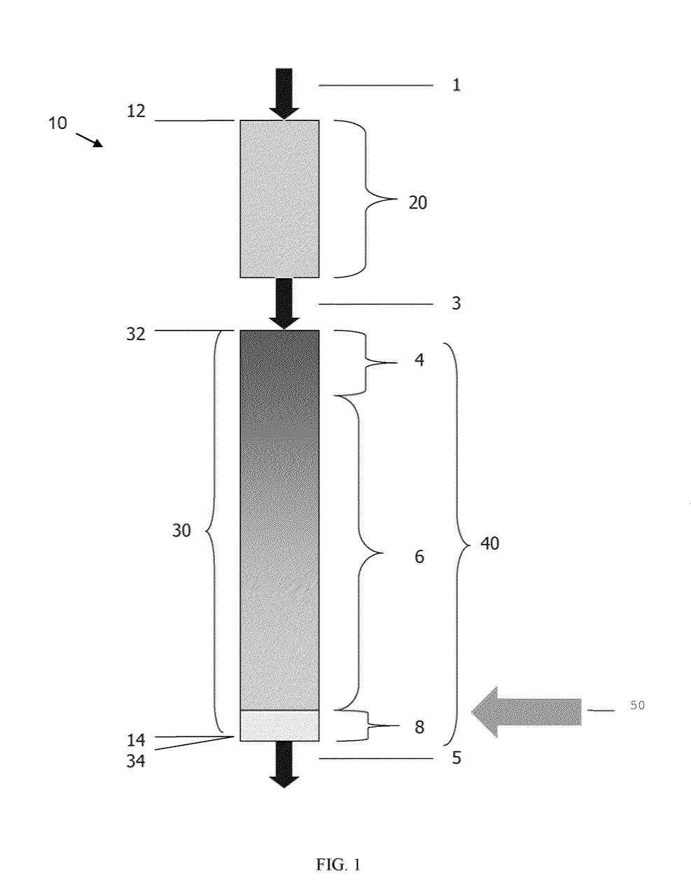

Referring to FIG. 1, in certain embodiments, a filter 10 having a flow path for a filtrate 3 may generally comprise an iodinated resin 20, wherein the iodinated resin 20 releases iodine into the filtrate 3, and an ion exchange column 30 downstream from the iodinated resin 20, the ion exchange column 30 may comprise at least one ion exchange resin 40, wherein the at least one ion exchange resin 40 progressively changes color as iodine is absorbed from the filtrate 3, and an indicator 50 to indicate when the amount of iodine in the iodinated resin 20 reaches a predetermined lower threshold. In at least one embodiment, the filter 10 may comprise an inlet 12 in fluid communication with an outlet 14. In at least one embodiment, the iodinated resin 20 and the ion exchange resin 40 may be intermediate the inlet 12 and the outlet 14. In at least one embodiment, the ion exchange column 30 may comprise a first end 32 upstream from a second end 34. In at least one embodiment, the second end 34 may comprise the outlet 14.

In certain embodiments, the influent 1 may enter the filter 10 via the inlet 12 and contact the iodinated resin 20, where iodine may be released into the fluid passing therethrough. The filtrate 3 may flow out of the iodinated resin 20 into the ion exchange column 30. The effluent 5 may flow out of the filter 10 via the outlet 14. In at least one embodiment, the ion exchange column 30 may comprise an ion exchange resin 40 having a dead zone 4, a reaction zone 6, and a pristine zone 8.

In certain embodiments, the amount of ion exchange resin 40 in the ion exchange column 30 may be designed to capture all of the iodine eluted from the iodinated resin 20 up to the end of the iodinated resin's 20 useful life. Therefore, the indicator 50 may be placed near the second end 34 or outlet 14 of the ion exchange column 30, such that when the indicator 50 shows a reaction zone 6 or a dead zone 4, the indicator 50 indicates that the amount of iodine remaining in the iodinated resin 20 has reached a predetermined lower threshold. In at least one embodiment, this threshold may indicate that the iodinated resin 20, ion exchange column 30, and/or the filter 10 are no longer intended for use.

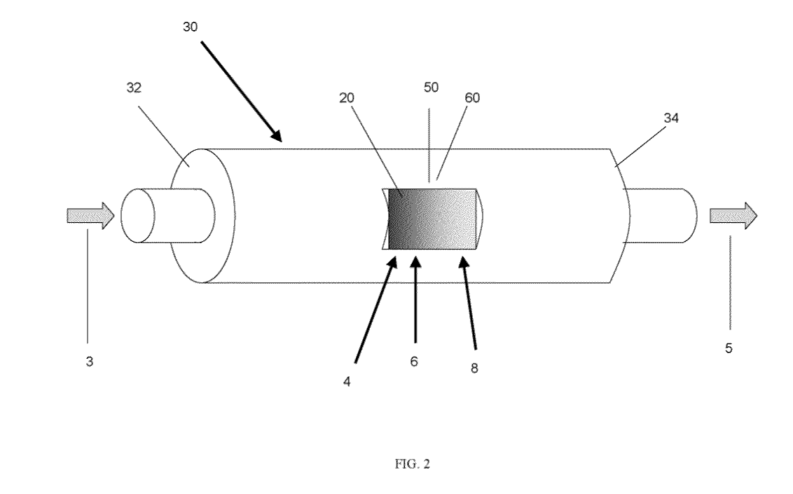

Referring to FIG. 2, in certain embodiments, the filter may generally comprise an ion exchange column 30 including an indicator 50 for indicating when the amount of iodine remaining in the iodinated resin reaches a predetermined lower threshold. In at least one embodiment, the indicator 50 may comprise a transparent portion 60 of the ion exchange column 30, wherein the color of the at least one ion exchange resin 40 is visible through the transparent portion 60. In at least one embodiment, the transparent portion 60 may comprise a substantial portion of the ion exchange column 30. In at least one embodiment, the transparent portion 60 may comprise the entire ion exchange column 30. In at least one embodiment, the entire ion exchange column 30 may be made of a substantially clear material, such that a color change is visible. In at least one embodiment, the transparent portion 60 may be intermediate the first end 32 and the second end 34. In at least one embodiment, the transparent portion 60 may be adjacent the second end 34. In at least one embodiment, the indicator 50 may comprise a window. In at least one embodiment, the indicator 50 may comprise a small window proximate to the second end 34. As generally used herein, “transparent portion” refers to a portion of the ion exchange column 30 that is substantially clear such that a color change of the ion exchange resin 40 and/or color indicator (not shown) in the ion exchange column 30 may be indicated.

In certain embodiments, in which a substantial portion of the ion exchange column 30 is made of a substantially clear material, a line (not shown) may be painted on the ion exchange column to form the indicator. One of ordinary skill in the art may readily describe other means of forming the indicator, such as notches, multiple lines, painted boxes, and the like. In certain embodiments, the indicator may be placed such that the filter is able to remove contaminants under substantially all conditions until the indicator indicates when the amount of iodine remaining in the iodinated resin has reached a predetermined lower threshold. In certain embodiments, sufficient iodine remains in the iodinated resin to ensure an adequate log kill of contaminants.

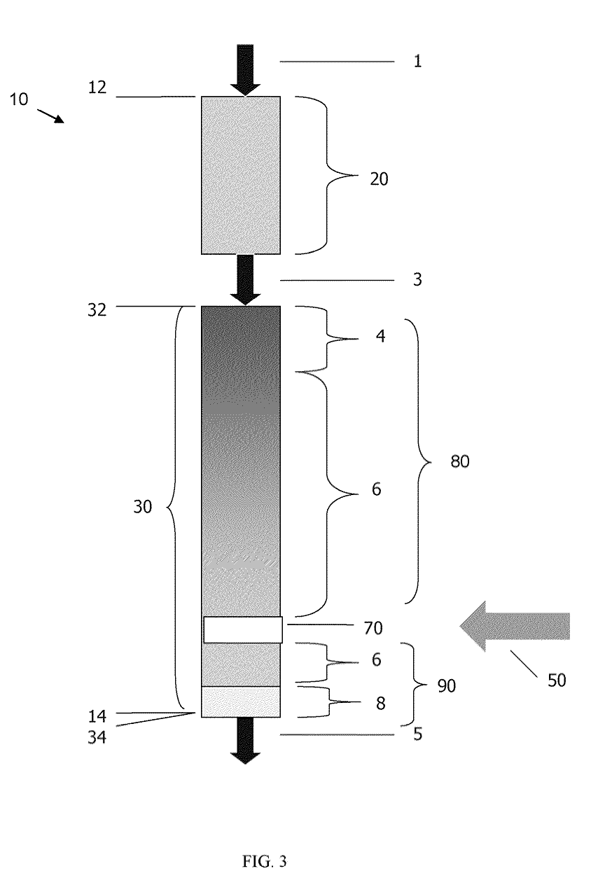

Referring to FIG. 3, in certain embodiments, the at least one ion exchange resin may comprise an indicator ion exchange resin 70 downstream from a first ion exchange resin 80, wherein the color of the indicator ion exchange resin 70 is visible through the transparent portion 50, and wherein the indicator ion exchange resin 70 has an iodine number greater than the first ion exchange resin 80. In at least one embodiment, the indicator ion exchange resin 70 may comprise the indicator 50. In at least one embodiment, the volume of the indicator ion exchange resin 70 may be less than the volume of the first ion exchange resin 80. In at least one embodiment, the volume of the indicator ion exchange resin 70 may be substantially less than the volume of the first ion exchange resin 80. In at least one embodiment, the volume of the indicator ion exchange resin 70 may be substantially equal to the volume of the first ion exchange resin 80. In at least one embodiment, the volume of the indicator ion exchange resin 70 may be greater than the volume of the first ion exchange resin 80. In at least one embodiment, the at least one ion exchange resin 40 comprises a second ion exchange resin 90 downstream from the indicator ion exchange resin 70. In at least one embodiment, the indicator ion exchange resin 70 may be adjacent the outlet 14.

In certain embodiments, the indicator ion exchange resin 70 may be calibrated to indicate when the amount of iodine remaining in the iodinated resin 20 has reached a predetermined lower threshold. In at least one embodiment, the indicator ion exchange resin 70 may change color as filtrate 3 passes therethrough. In at least one embodiment, the indicator ion exchange resin 70 may be compared to a reference indicia (not shown) in which a predetermined upper threshold of the indicator ion exchange resin 70 indicates when the amount of iodine remaining in the iodinated resin 20 has reached a predetermined lower threshold.

In certain embodiments, the filter may comprise a color indicator that progressively changes color as iodine is absorbed from the filtrate. In at least one embodiment, the color of the color indicator is visible through a transparent portion of the ion exchange column. In at least one embodiment, the color indicator may have a color sensitivity to iodine greater than the at least one ion exchange resin. In at least one embodiment, the color indicator may be selected from the group consisting of polypropylene alcohol fabrics and starch impregnated fabrics. In at least one embodiment, the color indicator may comprise polypropylene alcohol fabrics. In at least one embodiment, the color indicator may comprise starch impregnated fabrics.

In certain embodiments, the color indicator may be downstream from the iodinated resin. In at least one embodiment, the color indicator may be downstream from the at least one of an ion exchange resin. In at least one embodiment, the volume of the color indicator may be less than the volume of the at least one ion exchange resin. In at least one embodiment, the volume of the color indicator may be substantially less than the volume of the at least one ion exchange resin. In at least one embodiment, the volume of the color indicator may be substantially equal to the volume of the at least one ion exchange resin. In at least one embodiment, the volume of the color indicator may be greater than the volume of the at least one ion exchange resin. In at least one embodiment, the color indicator may be intermediate a first ion exchange resin and a second ion exchange resin. In at least one embodiment, the color indicator may be adjacent to the outlet.

In certain embodiments, the color indicator may be calibrated to indicate when the amount of iodine remaining in the iodinated resin has reached a predetermined lower threshold. In at least one embodiment, the color indicator may change color as filtrate passes therethrough. In at least one embodiment, the color indicator may be compared to a reference indicia in which a predetermined upper threshold of the color indicator indicates when the amount of iodine remaining in the iodinated resin has reached a predetermined lower threshold.

In certain embodiments, the indicator may comprise a sensor to measure the color of at least one of the ion exchange resin, indicator ion exchange resin, and color indicator. In at least one embodiment, the indicator comprises a sensor which senses the color of at least one of the ion exchange resin, indicator ion exchange resin, and color indicator in the ion exchange column, and transmits a signal indicating when the amount of iodine remaining in the iodinated resin reaches a predetermined threshold. In these embodiments, at least one of the sensor and signal may include mechanical and/or electrical means.

In certain embodiments, the filter may comprise a reference indicia corresponding to the predetermined lower threshold. The indicia, for example, may include written instructions, or may depict figures or a color palette to be compared to the indicator. In at least one embodiment, the color of the at least one ion exchange resin may be compared to the reference indicia. In at least one embodiment, the color of the indicator ion exchange resin may be compared to the reference indicia. In at least one embodiment, the color of the first ion exchange resin may be compared to the reference indicia. In at least one embodiment, the color of the second ion exchange resin may be compared to the reference indicia. In certain embodiments, the filter includes the indicia. In other embodiments, a system includes at least the filter including an iodinated resin, an ion exchange column including an indicator downstream from the iodinated resin, and the indicia.

### F. Methods of Use

In certain embodiments, methods of determining when a filter is no longer intended for use are described. These embodiments may generally comprise providing a filter having a flow path for a filtrate, comprising an iodinated resin, wherein the iodinated resin releases iodine into the filtrate, and an ion exchange column downstream from the iodinated resin, the ion exchange column comprising at least one ion exchange resin, wherein the at least one ion exchange resin progressively changes color as iodine is absorbed from the filtrate, and an indicator to indicate when the amount of iodine in the iodinated resin reaches a predetermined lower threshold, calibrating the ion exchange column to the predetermined lower threshold, and monitoring the indicator.

In certain embodiments, calibrating the ion exchange column to the predetermined lower threshold may comprise positioning the indicator along a portion of the ion exchange column that correlates to the predetermined lower threshold. In at least one embodiment, positioning the indicator along a portion of the ion exchange column that correlates to the predetermined lower threshold may comprise positioning a transparent portion of the ion exchange column, wherein the color of the at least one ion exchange resin is visible through the transparent portion. In at least one embodiment, the color of the indicator ion exchange resin is visible through the transparent portion. In at least one embodiment, the color of the color indicator is visible through the transparent portion.

In certain embodiments, calibrating the ion exchange column to the predetermined lower threshold may comprise determining the color of the at least one ion exchange resin correlating to an amount of iodine absorbed from the filtrate. In at least one embodiment, calibrating the ion exchange column to the predetermined lower threshold may comprise determining the color of the at least one ion exchange resin correlating to the predetermined lower threshold. In at least one embodiment, calibrating the ion exchange column to the predetermined lower threshold may comprise determining the color of the indicator ion exchange resin correlating to an amount of iodine absorbed from the filtrate. In at least one embodiment, calibrating the ion exchange column to the predetermined lower threshold may comprise determining the color of the indicator ion exchange resin correlating to the predetermined lower threshold. In at least one embodiment, calibrating the ion exchange column to the predetermined lower threshold may comprise determining the color of the color indicator correlating to an amount of iodine absorbed from the filtrate. In at least one embodiment, calibrating the ion exchange column to the predetermined lower threshold may comprise determining the color of the color indicator correlating to the predetermined lower threshold.

In certain embodiments, monitoring the indicator may comprise determining when an associated color of the ion exchange resin correlates to the predetermined lower threshold. In at least one embodiment, monitoring the indicator may comprise determining when an associated color of the indicator ion exchange column correlates to the predetermined lower threshold. In at least one embodiment, monitoring the indicator may comprise determining when an associated color of the color indicator column correlates to the predetermined lower threshold.

In certain embodiments, monitoring the indicator may comprise comparing the color of the at least one ion exchange resin to a reference indicia. In at least one embodiment, monitoring the indicator may comprise comparing the color of the indicator ion exchange resin to a reference indicia. In at least one embodiment, monitoring the indicator may comprise comparing the color of the color indicator to a reference indicia. In at least one embodiment, monitoring the indicator may comprise monitoring an electrical sensor to measure the color of the ion exchange resin. In at least one embodiment, monitoring the indicator may comprise monitoring an electrical sensor to measure the color of the indicator ion exchange resin. In at least one embodiment, monitoring the indicator may comprise monitoring an electrical sensor to measure the color of the color indicator.

In certain embodiments, the method may comprise replacing at least one of the ion exchange column and the at least one ion exchange resin when the indicator indicates that the amount of iodine remaining in the iodinated resin has reached the predetermined lower threshold. In at least one embodiment, the method may comprise replacing at least one of the ion exchange column and the at least one ion exchange resin before the indicator indicates that the amount of iodine remaining in the iodinated resin has reached the predetermined lower threshold. In at least one embodiment, the method may comprise replacing at least one of the ion exchange column and the at least one ion exchange resin after the indicator indicates that the amount of iodine remaining in the iodinated resin has reached the predetermined lower threshold. In at least one embodiment, the method may comprise replacing the indicator ion exchange resin when the indicator indicates that the amount of iodine remaining in the iodinated resin has reached the predetermined lower threshold. In at least one embodiment, the method may comprise replacing the color indicator when the indicator indicates that the amount of iodine remaining in the iodinated resin has reached the predetermined lower threshold.

All documents cited herein are, in relevant part, incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to the present invention.

While particular embodiments have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific devices and methods described herein, including alternatives, variants, additions, deletions, modifications and substitutions. This disclosure, including the appended claims, is intended to cover all such equivalents that are within the spirit and scope of this invention.

What is claimed is:

1. A filter having a flow path for a filtrate, comprising:
an iodinated resin, wherein the iodinated resin releases iodine into the filtrate; and
an ion exchange column downstream from the iodinated resin, the ion exchange column comprising:
at least one ion exchange resin, wherein the at least one ion exchange resin progressively changes color as iodine is absorbed from the filtrate; and
an indicator to indicate when the amount of iodine in the iodinated resin reaches a predetermined lower threshold.

2. The filter of claim 1, wherein the indicator comprises a transparent portion of the ion exchange column, wherein the color of the at least one ion exchange resin is visible through the transparent portion.

3. The filter of claim 2, wherein the transparent portion comprises a substantial portion of the ion exchange column.

4. The filter of claim 2, wherein the ion exchange column comprises a first end downstream from a second end, and wherein the transparent portion is adjacent to the second end.

5. The filter of claim 2, wherein the at least one ion exchange resin comprises an indicator ion exchange resin downstream from a first ion exchange resin, wherein the color of the indicator ion exchange resin is visible through the transparent portion, and wherein the indicator ion exchange resin has an iodine number greater than the first ion exchange resin.

6. The filter of claim 5, wherein the volume of the indicator ion exchange resin is substantially less than the volume of the first ion exchange resin.

7. The filter of claim 5, wherein the at least one ion exchange resin comprises a second ion exchange resin downstream from the indicator ion exchange resin.

8. The filter of claim 2 comprising a reference indicia corresponding to the predetermined lower threshold.

9. The filter of claim 1 comprising a color indicator that progressively changes color as iodine is absorbed from the filtrate, wherein the color of the color indicator is visible through a transparent portion of the ion exchange column.

10. The filter of claim 9, wherein the color indicator has a color sensitivity to iodine greater than the at least one ion exchange resin.

11. The filter of claim 9, wherein the color indicator is selected from the group consisting of polypropylene alcohol fabrics and starch impregnated fabrics.

12. The filter of claim 11, wherein the at least one ion exchange resin comprises a first ion exchange resin upstream from a second ion exchange resin, and wherein the color indicator is intermediate the first ion exchange resin and the second ion exchange resin.

13. A method comprising:
providing a filter having a flow path for a filtrate, comprising:
an iodinated resin, wherein the iodinated resin releases iodine into the filtrate; and
an ion exchange column downstream from the iodinated resin, the ion exchange column comprising:
at least one ion exchange resin, wherein the at least one ion exchange resin progressively changes color as iodine is absorbed from the filtrate; and
an indicator to indicate when the amount of iodine in the iodinated resin reaches a predetermined lower threshold;
calibrating the ion exchange column to the predetermined lower threshold; and
monitoring the indicator.

14. The method of claim 13 wherein calibrating comprises positioning the indicator along a portion of the ion exchange column that correlates to the predetermined lower threshold.

15. The method of claim 14, wherein positioning comprises positioning a transparent portion of the ion exchange column wherein the color of the at least one ion exchange resin is visible through the transparent portion.

16. The method of claim 13 wherein calibrating comprises determining the color of the at least one ion exchange resin correlating to an amount of iodine absorbed from the filtrate.

17. The method of claim 13 wherein calibrating comprises determining the color of the at least one ion exchange resin correlating to the predetermined lower threshold.

18. The method of claim 13, wherein monitoring comprises comparing the color of the at least one ion exchange resin to a reference indicia.

19. The method of claim 13 wherein the filter comprises a color indicator, and wherein calibrating comprises positioning the color indicator along a portion of the ion exchange column and determining the color of the color indicator correlating to the predetermined lower threshold.

20. The method of claim 13 comprising replacing at least one of the ion exchange column and the at least one ion exchange resin when the indicator indicates that the amount of iodine remaining in the iodinated resin has reached the predetermined lower threshold.
